(19) United States
(12) Patent Application Publication
(10) Pub. No.: US 2017/0106571 A1
(43) Pub. Date: Apr. 20, 2017

(54) System and Method for Producing a Vehicle Interior Component

(71) Applicant: Shanghai Yanfeng Jinqiao Automotive Trim Systems, Plymouth, MI (US)

(72) Inventor: Jesus Galen, Dusseldorf (DE)

(21) Appl. No.: 15/395,008

(22) Filed: Dec. 30, 2016

Related U.S. Application Data
(63) Continuation-in-part of application No. PCT/IB2015/001744, filed on Jul. 1, 2015.

(30) Foreign Application Priority Data
Jul. 1, 2014 (DE) 10 2014 109 174.4

(51) Int. Cl. B29C 43/02; B29C 43/34; B29C 43/36; B29C 43/52

(52) U.S. Cl. CPC B29C 43/02; B29C 43/52; B29C 43/34; B29C 43/36; B29C 2043/345; B29K 2105/12

(57) ABSTRACT

A system/apparatus and method for producing a vehicle interior component is disclosed. A vehicle interior component produced from a material comprising fibers is also disclosed. The method of making a component for use in a vehicle from a material comprising fibers may use a system/apparatus comprising a base section and a section creating a cavity for supply of fibers and a section for compression forming of a shape for the component. The method may comprise the steps of heating the base section to a first temperature; supplying a material comprising fibers between the base section and the section creating the cavity for fibers; activating at least some of the fibers of the material; and forming the material comprising fibers into the shape between the base section and the section for compression forming. The formed component from a material comprising fibers may provide properties (e.g. thickness, density, mass, strength, shape, form, contour, integrity, orientation, etc.) designed/intended for use in a vehicle interior; the formed component may comprise a uniform section providing consistent properties through the component and/or may comprise multiple subsections/portions that provide variations in properties between subsections/portions in the component designed/intended for use in the vehicle interior.

### CROSS REFERENCE TO RELATED APPLICATIONS

The present application is a continuation-in-part of PCT/International Application No. PCT/IB2015/001744 titled “SYSTEM AND METHOD FOR PRODUCING A VEHICLE INTERIOR COMPONENT” filed on Jul. 1, 2015.

The present application claims priority from and the benefit of and incorporates by reference in entirety of the following applications: (a) German Patent Application No. 10 2014 109 174.4 titled “VERFAHREN ZUM HERSTELLEN EINES FORMKÖRPERS AUS EINEM FASERMATERIAL SOWIE EINE VORRICHTUNG ZUM DURCHFÜHREN DES VERFAHRENS (METHOD FOR PRODUCING A FORM BODY FROM A FIBER MATERIAL AND AN APPARATUS FOR IMPLEMENTING THE METHOD)” filed on Jul. 1, 2014; and (b) PCT/International Application No. PCT/IB2015/001744 titled “SYSTEM AND METHOD FOR PRODUCING A VEHICLE INTERIOR COMPONENT” filed on Jul. 1, 2015.

### FIELD

The present invention relates to a system and method for producing a vehicle interior component. The present invention also relates to a component or part/body produced from a material comprising fibers. The present invention further relates to a system/apparatus and method for producing the component or part/body from a material comprising fibers.

### BACKGROUND

It is known to produce molded parts for a vehicle interior such as trim components that provide various properties desired for use in the vehicle interior. For example, it is generally desirable for such molded parts to be durable and be formed with a shape (e.g. three-dimensional form) to satisfy the functional and aesthetic demands of vehicle manufacturers (as well as others such as consumers); it is also generally desirable that the parts have low mass and be efficient to manufacture and install (e.g. to reduce the costs for the manufacturer).

It is known to form such molded parts from a material comprising fibers in an attempt to achieve reduced weight/mass. Certain known manufacturing techniques to produce a part from fibers may encounter challenges and inefficiencies (e.g. additional handling/steps in the process).

It would be advantageous to provide an improved system and method to produce a vehicle interior component such as a molded part from a material comprising fibers. It would also be advantageous to provide an improved vehicle interior component in the form of a molded part formed from a material comprising fibers.

### SUMMARY

The present invention relates to a method of making a component for use in a vehicle from a material comprising fibers using an apparatus comprising a base section and a section creating a cavity for supply of fibers and a section for compression forming of a shape for the component. The method may comprise the steps of heating the base section to a first temperature; supplying a material comprising fibers between the base section and the section creating the cavity for fibers; activating at least some of the fibers of the material; and forming the material comprising fibers into the shape between the base section and the section for compression forming. Activating at least some of the fibers of the material may comprise at least one of polymerization of at least some of the fibers or cross-linking of at least some of the fibers. The step of supplying the material may comprise fibers comprising blowing fibers into the cavity; the cavity may be vented. The section for compression forming may be heated. The base section may be heated during supplying the material into the cavity and during forming of the shape. The method may comprise activating at least some of the fibers by heating the section for compression forming; the section for compression forming may be heated to form and activate the fibers. The apparatus may comprise a mold. The method may comprise heating the section for compression forming to a second temperature for compressing the material between the base section to form the shape; the second temperature may be higher than the first temperature. The first temperature may be in a range from 150 degrees Celsius to 300 degrees Celsius. The step of supplying the material may comprise fibers comprising blowing the material comprising fibers into the cavity; the material may comprise fibers blown into the cavity is compressed into the shape by the section for compression forming. The fibers of the material may comprise fibers comprising at least one of a binder, a reinforcing material and a filler. The section creating the cavity may be permeable to air and impermeable to the fibers and impermeable to the at least one of the binder, the reinforcing material and the filler. The component with the shape may comprise one of a door panel, an instrument panel and a console of the vehicle.

The present invention also relates to a system for producing a component in a shape for use in a vehicle from a material comprising fibers. The system may comprise a first mold stage providing a cavity for fibers to be supplied comprising a base section and a section to define the cavity; a supply of the material comprising fibers into the cavity; a second mold stage for forming the shape comprising the base section and a section to form the shape by compression forming. The base section may be configured to be heated to a first temperature; the section defining the cavity may be vented; the section to form the shape may be configured to be heated to a second temperature. The first temperature may be in a range from 150 degrees Celsius to 300 degrees Celsius; the second temperature may be higher than the first temperature. The first temperature may be at least equal to an activation temperature of a fiber of the material comprising fibers. The base section and the section to form the shape may comprise a compression mold; the shape may comprise a compression formed shape. The material may comprise fibers remaining uncompressed until the compression mold is closed to compression form the shape from the material comprising fibers.

The present invention further relates to a method of making a component for use in a vehicle from a material comprising fibers using an apparatus comprising a base section and a section creating a cavity for supply of fibers and a section for compression forming of a shape for the component. The method may comprise heating the base section to a first temperature; supplying a material comprising fibers between the base section and the section creating the cavity for fibers; activating at least some of the fibers of the material; and forming the material comprising fibers into the shape between the base section and the section for compression forming. The material comprising fibers may be supplied on the base section and compressed into the shape on the base section; the section creating a cavity may be vented for blowing in fibers; the section for compression forming may be heated to form the shape and activate fibers of the material comprising fibers.

The present invention further relates to a component for use within an interior of a vehicle. The component includes a first section having a first density and a first thickness and a second section extending from the first section and having a second density and a second thickness. Each section includes a material comprising fibers having an orientation; and at least one of the orientation, the density, and the second thickness of the second section is configured relative to the orientation, the density, and the second thickness of the first section to provide properties (e.g. thickness, density, mass, strength, shape, form, contour, integrity, orientation, etc.) of the second section that are different than properties (e.g. thickness, density, mass, strength, shape, form, contour, integrity, orientation, etc.) of the first section.

The present invention further relates to a component for use within an interior of a vehicle. The component includes a first section having a first density and a first thickness; a second section having a second density and a second thickness; and a transition between the first section and the second section. The first section comprises a material comprising fibers having an orientation, and the second section comprises a material comprising fibers having an orientation. The orientation of fibers of the first section and the orientation of fibers of the second section are generally maintained across the transition. The fibers are also supplied to the first section and to the second section in an operation.

The present invention further relates to a method of making a component for use in a vehicle from material comprising fibers utilizing a mold that includes at least a first part and a second part, wherein each of the first and second parts includes a surface that defines a cavity. The method includes heating at least one of the first and second parts of the mold to a first temperature; supplying a material comprising fibers into the cavity; and compressing the material using at least one of the first and second parts of the mold to form the component.

The present invention further relates to a system for producing a component for use in a vehicle from a material comprising fibers. The system includes a first mold, a second mold, a feeder, and a heater. The first mold includes a first part having a surface and a second part that is movable relative to the first part between a closed position and an open position. The second part has a surface; and the surfaces of the first part and second part define a first cavity. The feeder is configured to introduce the fibers of the material into the first cavity when the first mold is in the closed position. The second mold includes the first part and a third part that is movable relative to the first part between an open position and a closed position. The third part has a surface. The heater is configured to heat at least one of the first part, second part and third part to a first temperature. When the second part is in the open position, the first part is movable from the first mold to the second mold to move the fibers from the first mold to the second mold for compression between the surfaces of the first and third parts when the second mold is in the closed position.

The present invention further relates to a method of making a panel of a vehicle from a material comprising fibers utilizing a mold comprising first and second parts and movable between an open position and a closed position, where each of the first part and second part includes a mold surface. The method includes heating at least one of the first part and second part of the mold to a first temperature that is at least equal to a threshold activation temperature of the material comprising fibers; introducing a supply of the material comprising fibers into the mold when in the open position; and moving the mold to the closed position to apply a compression force to the material comprising fibers in a cavity between the mold surfaces of the first part and second part. The method may be carried out in the order provided.

The present invention further relates to a device for producing a panel of a vehicle from a material comprising fibers. The device includes a first mold, a feeder, a second mold, and a heating mechanism. The first mold includes a first part having a first mold surface and a second part that is movable relative to the first part between a closed position and an open position. The second part has a second mold surface. The feeder is configured to introduce the material comprising fibers into a cavity defined by the first and second mold surfaces when in the closed position. The second mold includes the first part of the first mold and a third part that is movable relative to the first part between a closed position and an open position. The heating mechanism is configured to heat at least one of the first part, second part, and the third part to a first temperature that is at least equal to a threshold activation temperature of the material comprising fibers. When the second part is in the open position, the first part is movable from the first mold to the second mold to move the material comprising fibers from the first mold to the second mold.

The present invention further relates to a panel for use in an interior of a vehicle that is subjected to a first load at a first location and a second load at a second location that is higher than the first load. The panel includes a first section including a material comprising fibers and having a first density and a first thickness. The panel also includes a second section extending from the first section. The second section includes the material comprising fibers and has a second density and a second thickness. At least one of the second density and the second thickness is greater than the first density and the first thickness such that the second section is configured to be subjected to the second load and the first section is configured to be subjected to the first load.

The present invention further relates to a system and method that may be configured to produce a formed component from a material comprising fibers having properties (e.g. thickness, density, mass, strength, shape, form, contour, integrity, orientation, etc.) designed/intended for use in a vehicle interior; the formed component may comprise a uniform section providing consistent properties through the component and/or may comprise multiple subsections/portions that provide variations in properties between subsections/portions in the component designed/intended for use in the vehicle interior.

### FIGURES

FIG. 1A is a schematic perspective view of a vehicle according to an exemplary embodiment.

FIG. 1B is a schematic perspective view of a vehicle interior according to an exemplary embodiment.

FIG. 2A is a schematic perspective view of a component for use with a vehicle according to an exemplary embodiment.

FIG. 2B is a schematic perspective view of a component for use with a vehicle according to an exemplary embodiment.

FIG. 3 is a schematic diagram of a method of making a component such as a panel of a vehicle according to an exemplary embodiment.

FIGS. 4A to 4F are schematic diagrams of a method of making a component (indicated in FIG. 4F) for use in a vehicle according to an exemplary embodiment.

FIGS. 5A to 5F are schematic diagrams of a method of making a component (indicated in FIG. 5F) for use in a vehicle according to an exemplary embodiment.

FIGS. 6A to 6F are schematic diagrams of a method of making a component (indicated in FIG. 6F) for use in a vehicle according to an exemplary embodiment.

FIG. 7A is a schematic section view of the component showing orientation of fibers in an article/component such as a panel or deposit/preform according to an exemplary embodiment.

FIG. 7B is a schematic section view of the component showing orientation of fibers in an article/component such as a panel or deposit/preform according to an exemplary embodiment.

FIG. 8A is a schematic diagram indicating variations of properties such as density of a component produced from a material comprising fibers according to an exemplary embodiment.

FIG. 8B is a schematic view of a component prior to compression according to an exemplary embodiment.

FIG. 8C is a schematic view of the component after compression according to an exemplary embodiment.

FIG. 8D is a schematic view of a component according to an exemplary embodiment.

FIG. 9A is a schematic diagram indicating variations of properties such as thickness/density of a component produced from a material comprising fibers according to an exemplary embodiment.

FIG. 9B is a schematic view of a component having a change in thickness according to an exemplary embodiment.

FIG. 9C is a schematic view of a component having a change in thickness/density according to an exemplary embodiment.

FIG. 10A is a schematic section side view of an apparatus for producing a component/part according to an exemplary embodiment.

FIG. 10B is a schematic section side view of an apparatus for producing a component/part according to an exemplary embodiment.

FIG. 11 is a schematic diagram of a method for producing a component/part according to an exemplary embodiment.

FIG. 12A is a schematic perspective view of a component for use with a vehicle according to an exemplary embodiment.

FIG. 12B is a schematic perspective view of the component used with a support according to an exemplary embodiment.

FIG. 12C is a schematic diagram of a method of making a component such as a panel of a vehicle according to an exemplary embodiment.

### DESCRIPTION

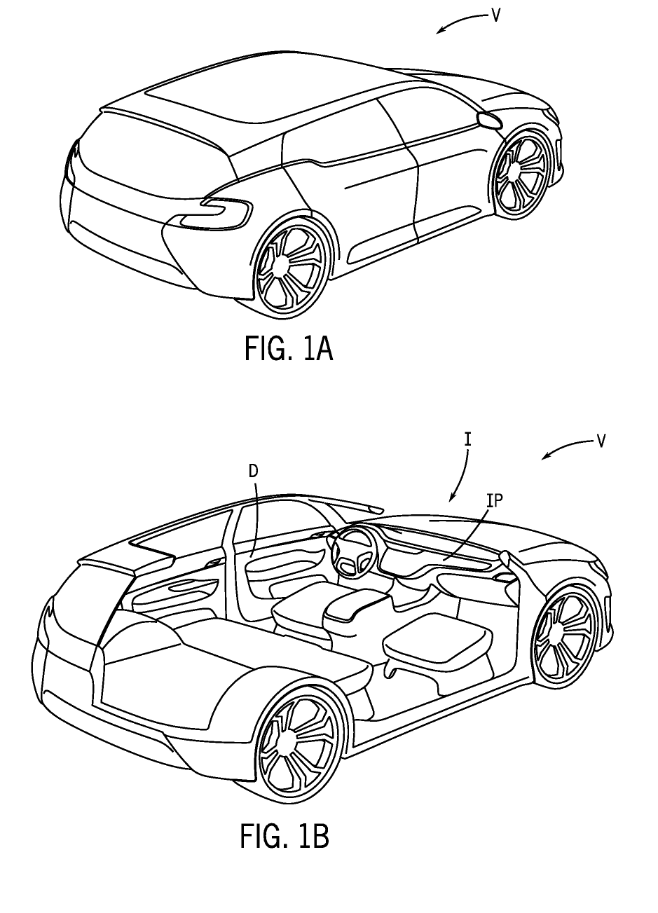

Referring to FIGS. 1A and 1B, a vehicle V providing a vehicle interior I with component such as an instrument panel IP and door panel (for door D) is shown schematically according to an exemplary embodiment.

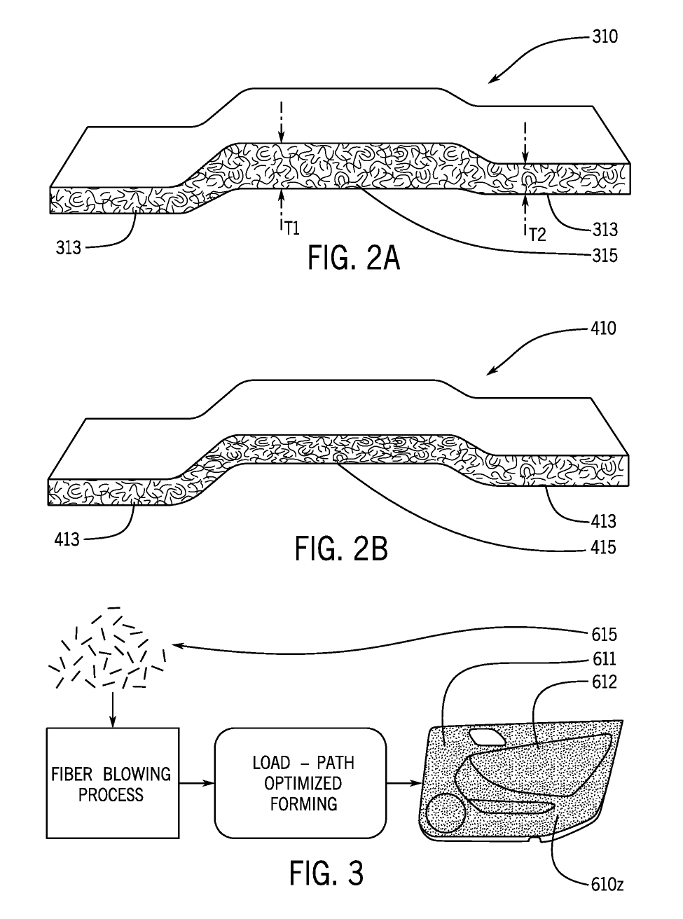

As indicated schematically in FIGS. 2A and 2B, the component may be formed from a panel 310 or 410 shown as comprised of a material comprising fibers (e.g. natural fibers, nonwoven fibers, etc.). According to an exemplary embodiment, the panel may be provided with a shape generally conforming to the final/intended shape of the component; the shape/geometry of the panel may comprise variations in thickness (e.g. as shown schematically for the panel/component compare generally expanded thickness/density T1 with generally compressed thickness/density T2). See also FIGS. 1B, 8A-8D and 9A-9C. As indicated schematically in FIGS. 2A and 2B, sections of the panel may be conformed to the design of the component (e.g. panel 310 with variable density/thickness sections 313 and 315 and panel 410 with generally consistent thickness and variable density sections 413 and 415). See also FIG. 1B. According to an exemplary embodiment, the formed component from a material comprising fibers may provide properties (e.g. thickness, density, mass, strength, shape, form, contour, integrity, orientation, etc.) designed/intended for use in a vehicle interior; the formed component may comprise a uniform section providing consistent properties through the component and/or may comprise multiple subsections/portions that provide variations in properties between subsections/portions in the component designed/intended for use in the vehicle interior. See e.g. FIGS. 1B, 2A-2B, 7A-7B, 8A-8D and 9A-9C.

Referring to FIG. 3, as shown schematically according to an exemplary embodiment, a fiber panel 610z (shown schematically/representationally as a component in the form of a door panel) may be formed in a process in which fibers 615 are provided in a material/mass (e.g. supplied such as by fiber blowing, injection, etc.) and formed (e.g. such as by compression forming/molding, pressing, etc.) into the general shape of the component; as produced according an exemplary embodiment of the system/method, the component (shown schematically representationally as door panel 610x) may have sections 611 and 612 with variations in shape/form and/or density/thickness (or other properties). See e.g. FIGS. 1B, 2A-2B, 7A-B, 8A-8D and 9A-9C.

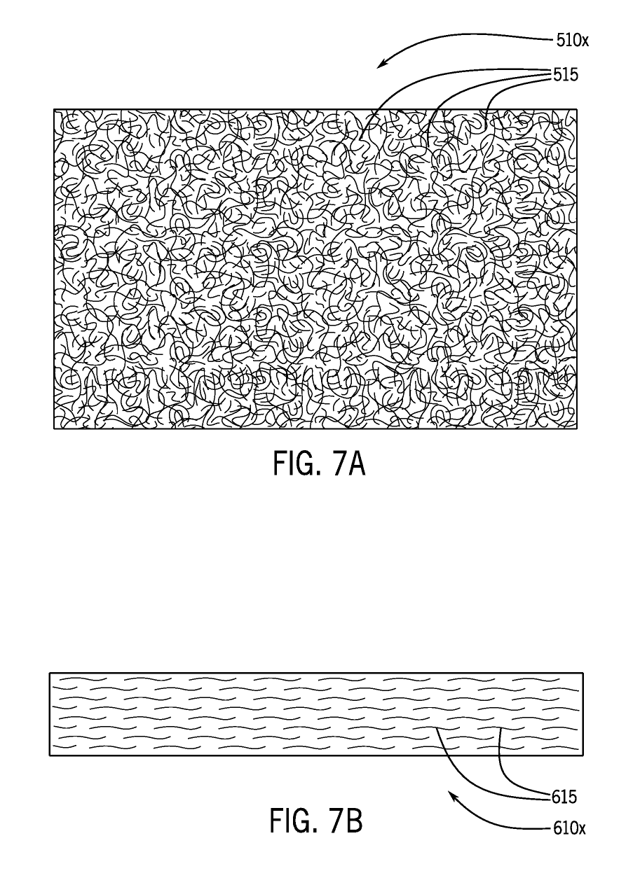

According to an exemplary embodiment as shown schematically, the vehicle interior component (e.g. such as formed panel 310, panel 410, panel 510/510x, panel 610/610x, panel 610z, trim component 710, component 810, etc.) can be formed with a material comprising fibers (e.g. material comprising fibers such as fibers 515/615 with other constituents such as in a binder, other/varying fiber content, etc. according to the designed/intended use and properties) in a system/apparatus and method/process as shown schematically in FIGS. 2A-2B, 3 and 4A-4F. See also FIGS. 7A and 7B.

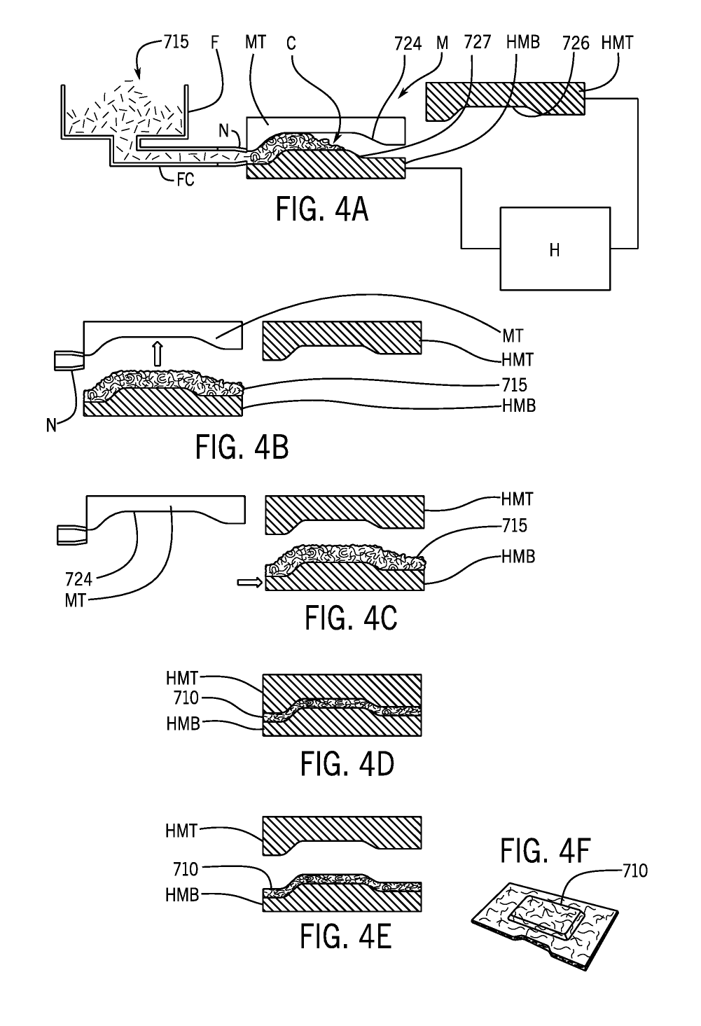

According to an exemplary embodiment, the component (e.g. formed panel) may be produced in a tool/apparatus shown as mold system M (e.g. multi-step/multi-stage system) comprising a mold base section shown as heated mold base/bottom section HMB with a mold top section shown as vented mold top section MT (e.g. in step/stage for providing a cavity C for supply of the material comprising fibers in a mass for preform/initial forming) as a mold top section shown as a heated mold top section HMT (e.g. in step/stage for compression forming the component). See FIGS. 3 and 4A-4E. As shown schematically in FIGS. 4A-4B, fibers (e.g. provided in a material comprising fibers) are supplied from a source shown as feeder/system F through a supply line shown as channel FC and by a port shown as nozzle N into the cavity C in the mold/apparatus M established between the mold base section HMB and the mold top section MT; as indicated the mass/material comprising fibers is provided in an initial form (e.g. such as a preform) on the mold bottom section HMB for next step/next stage processing (e.g. compression-forming of the component with shape/form in heated mold apparatus) with mold top section HMT with heat supplied by heating system/heat source H. See generally FIGS. 4A-4E.

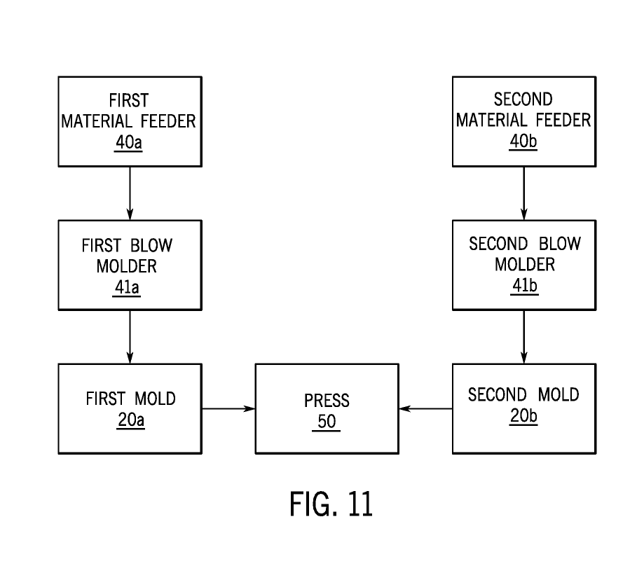

As shown schematically in FIGS. 4A-4E, fiber/material 715 is supplied (e.g. blown) into the cavity C in mold system/apparatus M and heated at the mold base section HMB (e.g. to a temperature to activate the fibers/material); as indicated schematically mold top section MT is vented for the supply/blowing of fiber/material; the material comprising fibers supplied in cavity C of mold/apparatus M between surface 724 of mold section MT and surface 727 of mold section HMB (e.g. as for initial forming/preforming of fiber/material or mass 715) in the system/method according to an exemplary embodiment. As shown schematically, the mold stage M to form the component/panel comprises the heated mold top section HMT with surface 726 which with heated mold bottom section HMB with surface 727 is operated to compression form the fiber panel/mass 715 into the component/panel 710 (e.g. with heating/activation of the fiber mass 715 between surfaces 726 and 727). According to an exemplary embodiment as shown schematically and representationally in FIGS. 4A-4E, the (uncompressed/blown) initial fiber mass 715 and the (compressed/formed) fiber panel/component 710 are produced in a sequence/process in which the fiber mass/fiber panel remain on the mold base section HMB (e.g. for process steps/stages of supplying the material/mass comprising fibers in the cavity and compression-forming the material/mass comprising fibers into the component). See also FIGS. 3 and 11.

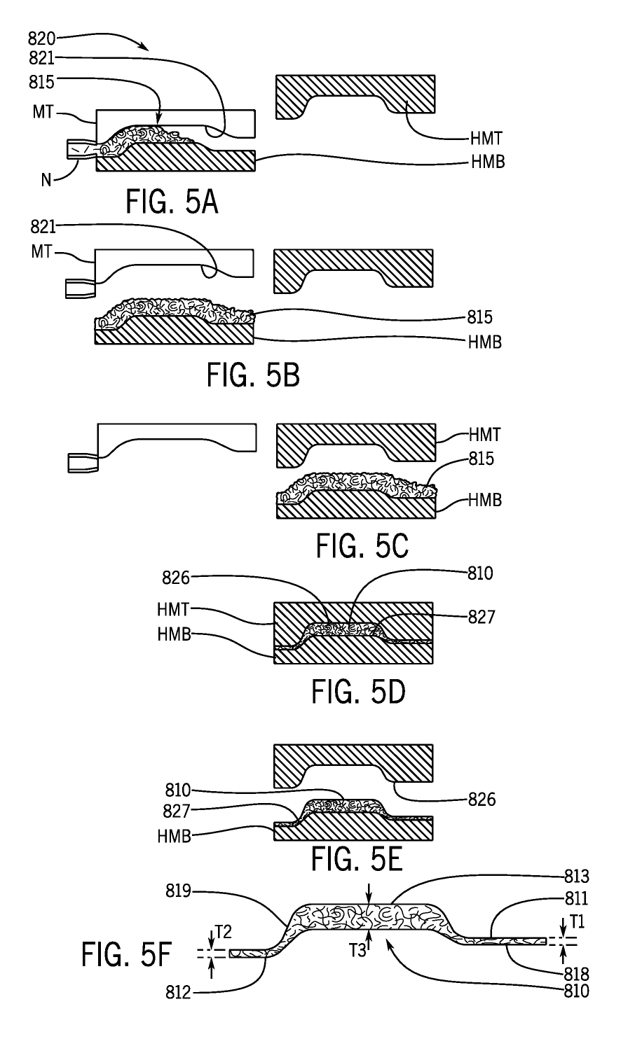

As shown schematically according to an exemplary embodiment in FIGS. 5A to 5F, a component shown as panel 810 can be formed from a material comprising fibers (e.g. from a fiber material/mass 815) supplied/blown into the cavity of the mold stage with (heated) base section HMB (providing surface 827) and (vented) top section MT (providing surface 821); as indicated schematically, the component may be formed with variations in shape and form such as variations in thickness (shown as sections 811 and 812 and 813 with thickness T1 and T2 and T3 with transitions/sections 818 and 819) formed by the mold stage with (heated) base section HMB (providing surface 827) and (heated) top section HMT (providing surface 826).

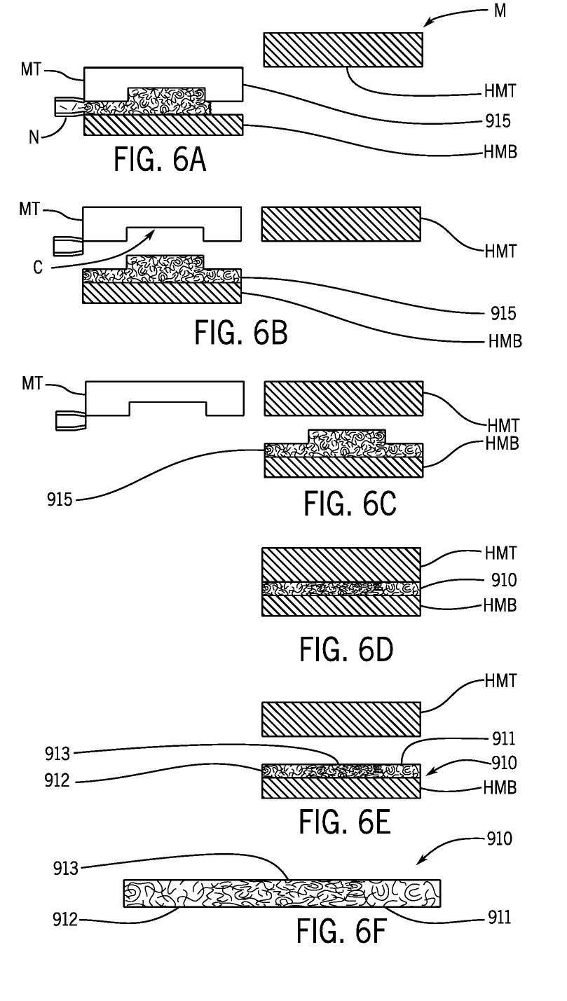

As shown schematically according to an exemplary embodiment in FIGS. 6A to 6F, a component shown as panel 910 can be formed from a material comprising fibers (e.g. from a fiber material/mass 915) supplied/blown into the cavity of the mold stage with (heated) base section HMB and (vented) top section MT; component may be formed with variations in shape and form such as variations in density (shown as sections 911 and 912 and 913) formed by the mold stage with (heated) base section HMB and (heated) top section HMT (e.g. shape for component formed in compression between surface of mold section HMB and surface of mold section HMT as designed/configured). See generally FIGS. 3 and 6A-6E. See also FIGS. 4A-4E and 5A-5E.

As indicated schematically according to an exemplary embodiment in FIGS. 6A to 6C, deposited fibers 915 in the cavity between (heated) mold bottom section HMB and (vented) mold top section MT comprise a larger thickness (e.g. mass) of fibers at a section 913 (e.g. with the mass of material comprising fibers 915 supplied into the cavity in mold system/apparatus M). See also FIGS. 6D to 6F and 8A-8D, 9A-9C. As indicated schematically according to an exemplary embodiment in FIGS. 6C to 6E deposited fibers 915 (e.g. material) on (heated) mold bottom section HMB are provided a form (e.g. shape) by (heated) mold top section HMT; the mold system/apparatus is closed and heated to form the compression formed fiber panel 910 with section 913 having greater density than section 911 and section 912 (e.g. at same thickness). See also FIGS. 2A-2B, 8A-8D and 9A-9C.

As indicated schematically according to an exemplary embodiment in FIGS. 7A and 7B, fibers from material comprising fibers can be supplied/arranged/oriented to provide a fiber panel having generally random pattern/matrix (e.g. fiber panel 510x with fibers 515 as shown schematically and representationally in FIG. 7A) or having a generally aligned pattern/matrix (e.g. fiber panel 610x with fiber 615 as shown schematically and representationally in FIG. 7B) or with a variation of pattern/matrix of fibers.

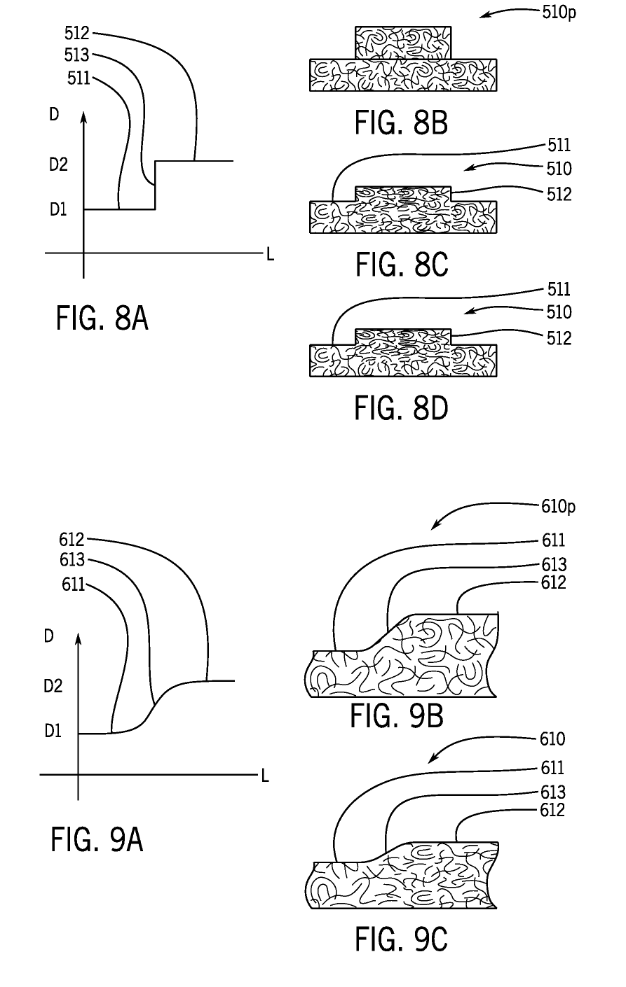

As indicated schematically according to an exemplary embodiment in FIG. 1B, vehicle interior components having a wide variety of physical forms (e.g. size, shape, appearance, etc.) and mechanical properties (e.g. strength, mass/weight, density, section, etc.) can be formed according to an exemplary embodiment of the system/method (e.g. by variations in the process steps/stages and/or the mold/tool sections and/or operating conditions and/or composition/formulation of the material comprising fibers, etc. to vary the mass, form, shape, thickness, density, arrangement, composition, finish, etc. of the component). See also FIGS. 2A-2B, 3, 4G, 5G, 6G, 7A-7B, 8A-8D and 9A-9C. As indicated schematically in FIGS. 8A-8D according to an exemplary embodiment a component such as panel 510 may be formed with variations in density and/or thickness of portions/subsections (e.g. as a multi-segment composite of subsection 512 on subsection/substrate 511 of material/composite/mass 510p compression formed into component/part 510). As indicated schematically in FIGS. 9A-9C according to an exemplary embodiment a component such as panel 610 may be formed with variations in thickness and/or density of portions/subsections (e.g. subsection 612 with subsection 611 and transition subsection 613 of material/mass 610p compression-formed into component/part 610). See also FIG. 3 (showing schematically component in the form of door panel 610x). According to an exemplary embodiment the system/method may produce components with design/form (e.g. including thickness/density) in variation for sections/subsections of the component or with uniformity for the component based on the configuration of the tool/apparatus (e.g. mold sections/surfaces) for the system/method as indicated schematically in FIGS. 1B, 2A-2B, 3, 4A-G, 5A-5G, 6A-6G, 7A-7B, 8A-8D and 9A-9C.

According to an exemplary embodiment as shown schematically as a method of making a component for use in a vehicle from a material comprising fibers using an apparatus comprising a base section and a section creating a cavity for supply of fibers and a section for compression forming of a shape for the component is provided. See e.g. FIGS. 3, 4A-4E, 5A-5E, 6A-6E and 11. According to an exemplary embodiment as shown schematically, the method may comprise the steps of heating the base section to a first temperature; supplying a material comprising fibers between the base section and the section creating the cavity for fibers; activating at least some of the fibers of the material; and forming the material comprising fibers into the shape between the base section and the section for compression forming. See e.g. FIGS. 3, 4A-4E, 5A-5E, 6A-6E and 11. As shown schematically, activating at least some of the fibers of the material may comprise at least one of polymerization of at least some of the fibers or cross-linking of at least some of the fibers. According to an exemplary embodiment as shown schematically, the step of supplying the material may comprise fibers comprises blowing fibers into the cavity; the cavity may be vented. See e.g. FIGS. 3, 4A, 5A and 6A. According to an exemplary embodiment as shown schematically, the section for compression forming may be heated; the method may comprise heating the base section during forming of the shape; the base section may be heated during the process of supplying the material into the cavity. See e.g. FIGS. 3, 4B, 5B and 6B. The method may comprise activating at least some of the fibers by heating the section for compression forming. According to an exemplary embodiment, supplying the material may comprise fibers comprises blowing fibers; the section creating a cavity may be vented for blowing in fibers. See e.g. FIGS. 3, 4A, 5A and 6A. According to an exemplary embodiment, the section for compression forming may be heated to form and activate the fibers. According to an exemplary embodiment, the apparatus may comprise a mold. See e.g. FIGS. 3, 4A-4E, 5A-5E and 6A-6E. The method may comprise heating the section for compression forming to a second temperature prior to compressing the material between the base section to form the shape; the second temperature may be higher than the first temperature; the first temperature may be in a range from 150 degrees Celsius to 300 degrees Celsius.

According to an exemplary embodiment, supplying the material may comprise fibers comprises blowing the material comprising fibers into the cavity; the material may comprise fibers blown into the cavity is compressed into the shape by the section for compression forming. See e.g. FIGS. 3, 4A-4E, 5A-5E and 6A-6E. The fibers of the material may comprise fibers blown into the cavity with at least one of a binder, a reinforcing material and a filler. According to an exemplary embodiment, the section creating the cavity may be permeable to air and impermeable to the fibers and impermeable to the at least one of the binder, the reinforcing material and the filler. See e.g. FIGS. 3, 4A, 5A and 6A. According to an exemplary embodiment as shown schematically, the component with the shape may comprise one of a door panel, an instrument panel, a console, etc. of the vehicle. See e.g. FIGS. 1B, 2A-2B, 3, 4F, 5F and 6F.

According to an exemplary embodiment as shown schematically, a system for producing a component in a shape for use in a vehicle from a material comprising fibers. The system may comprise a first mold stage providing a cavity for fibers to be supplied comprising a base section and a section to define the cavity; a supply of the material comprising fibers into the cavity; a second mold stage for forming the shape comprising the base section and a section to form the shape by compression forming. See e.g. FIGS. 3, 4A-4E, 5A-5E, 6A-6E and 11. According to an exemplary embodiment as shown schematically, the base section may be configured to be heated to a first temperature; the section defining the cavity may be vented; the section to form the shape may be configured to be heated to a second temperature. See e.g. FIGS. 3, 4A-4E, 5A-5E and 6A-6E. According to an exemplary embodiment, the first temperature may be in a range from 150 degrees Celsius to 300 degrees Celsius; the second temperature may be higher than the first temperature; the first temperature may be at least equal to an activation temperature of a fiber of the material comprising fibers. As shown schematically, the base section and the section to form the shape may comprise a compression mold; the shape may comprise a compression formed shape. See e.g. FIGS. 1B, 2A-2B, 3, 4E-4F, 5E-5F and 6E-6F. According to an exemplary embodiment, the material may comprise fibers remains uncompressed until the compression mold is closed to compression form the shape from the material comprising fibers. See e.g. FIGS. 3, 4A-4B, 5A-5B and 6A-6B.

According to an exemplary embodiment as shown schematically, a method of making a component for use in a vehicle from a material comprising fibers using an apparatus comprising a base section and a section creating a cavity for supply of fibers and a section for compression forming of a shape for the component is provided. See e.g. FIGS. 3, 4A-4E, 5A-5E, 6A-6E and 11. As shown schematically, the method may comprise the steps of heating the base section to a first temperature; supplying a material comprising fibers between the base section and the section creating the cavity for fibers; activating at least some of the fibers of the material; and forming the material comprising fibers into the shape between the base section and the section for compression forming. See e.g. FIGS. 3, 4A-4E, 5A-5E, 6A-6E and 11. According to an exemplary embodiment, the material comprising fibers may be supplied on the base section and compressed into the shape on the base section. See e.g. FIGS. 3, 4E-4F, 5E-5F and 6E-6F. As shown schematically, the section creating a cavity may be vented for blowing in fibers; the section for compression forming may be heated to form the shape and activate fibers of the material comprising fibers. See e.g. FIGS. 3, 4A-4E, 5A-5E and 6A-6E.

As indicated schematically in FIG. 11 according to an exemplary embodiment, the system to produce the component from the material comprising fibers may comprise a workstation comprising multiple material feeders/feed systems with mold sections/apparatus to provide the cavity for initial supply (e.g. blowing) of the material comprising fibers; the workstation may share a section/apparatus for forming the component from the material comprising fibers (e.g. mold press, section for compression forming, etc.); as indicated, the apparatus in a workstation according to an exemplary embodiment may be configured with an intent of optimizing workflow/load-path to produce/form the components (e.g. in view of cycle time, etc. for each step/operation of the method as implemented). See also FIG. 3.

### Exemplary Embodiments

Referring to the FIGURES, the systems/methods of producing various components (e.g., molded bodies, panels, etc.) for use in vehicles from a material comprising fibers as shown schematically according to an exemplary embodiment. According to an exemplary embodiment, the components may be produced having different densities and/or different thicknesses in different sections (e.g. regions, portions, parts, etc. of the component to better manage the load/conditions of use of the component when installed in a vehicle). See FIGS. 1B, 2A-2B, 4F, 5F, 6F, 7A-7B, 8A-8D and 9A-9C. See also FIG. 3.

According to an exemplary embodiment, the methods for producing compartments such as molded bodies from a material comprising fibers utilize a mold that includes at least one bottom section and at least one top section able to be moved toward one another to exert a compression/pressing force on the material comprising fibers (e.g. with an intermediate mold space or cavity for the molded body to be produced). According to an exemplary embodiment, the method may include multiple steps/processes: (a) bringing or holding at least one of the mold parts to/at a first and/or the first process temperature able to at least partly activate the respective material comprising fibers; (b) introducing the material comprising fibers into the at least partly open mold; (c) bringing the mold into its closed position and exerting the pressing force to form the molded body. See FIGS. 3, 4A-4E, 5A-5E, 6A-6E and 11.

According to an exemplary embodiment, the mold may be moved from an open into a closed position (or partly closed position) providing a cavity for introducing the material comprising fibers for the molded body to be produced (such as by blowing in material from a supply/source through a nozzle) is as unobstructed as possible. According to an exemplary embodiment as shown schematically, the pressing force required for molding is not applied until the mold is in its closed position. See FIGS. 3, 4A-4E, 5A-5E, 6A-6E and 11.

According to an exemplary embodiment, at least one or both of the mold sections parts (i.e., at least the top part or the bottom part) are configured to already be at a temperature suitable to at least partly activate the material comprising fibers at least in the areas which come into contact with the material comprising fibers to be pressed when the material comprising fibers is introduced into the intermediate mold space. The temperature constitutes the first process temperature; the part or parts of the mold may be already at the first process temperature prior to the first method step; if different process temperatures are employed, the part or parts of the mold are brought to the first process temperature in a method step.

According to an exemplary embodiment, the activating of the material comprising fibers is generally a thermal activation of a duroplastic binding agent in the material comprising fibers to the temperature which the parts of the mold are already at. Before the setting process is finished, the mold is then brought into its closed position and the pressing force applied so that a very stable molded body having outstanding mechanical properties is formed in the desired three-dimensional shape.

According to an exemplary embodiment, the intermediate mold space may (e.g. cavity) be provided in the partly open state of the mold; the material may be introduced into the intermediate mold space (e.g. blown in). See e.g. FIGS. 4A. The contact pressure is just not applied on the mold until the material comprising fibers is introduced; i.e., the state at which the contact pressure is applied is then designated the closed state of the mold.

According to an exemplary embodiment, since no separate heated flow of air needs to be introduced into the closed mold in order to heat up the fibers (as in a conventional method) the forming/molding process may use a single apparatus/tool (e.g. one suitable (heavyweight) molding tool) able to be subjected to high pressing force in a press. The pressing force may be in the range of approximately two tons.

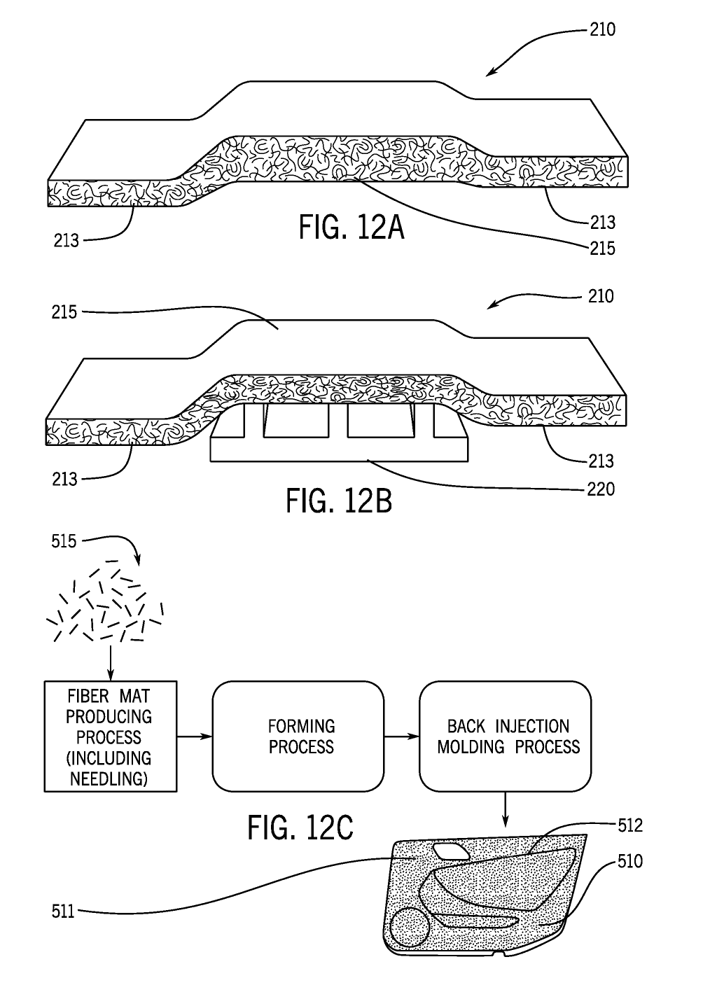

The molded body does not need to be transported between multiple molding tools/apparatus to be formed does not need to be brought into different molding tools. Producing and handling a semi-finished product is unnecessary; according to an exemplary embodiment as shown schematically, the method enables forming the finished molded body directly. See FIGS. 3 and 12C.

Directly heating at least one of the parts of the mold (i.e., the molding tool) facilitates a continuous duroplastic molding process (which may improve the mechanical properties of the molded body produced). See e.g. FIGS. 4A and 4F.

The first process temperature is in a range of between 150 degree Celsius and 300 degree Celsius and approximately 220 degree Celsius (e.g. a suitable temperature range to enable the curing process of the utilized binding agents). According to an exemplary embodiment, the entire molding process is intended to proceeds reliably and consistently so as to be able to obtain a uniform material quality to the molded body to be produced.

According to an exemplary embodiment, at least one of the parts of the mold (e.g., both parts of the mold) may be brought to or held at a second process temperature during the method step of bringing the mold into its closed position and applying the pressing force for forming the molded body. See FIGS. 3 and 4A. A second process temperature may be higher than the first process temperature (e.g. first achieve a pre-activation and then a final activation of the components of the material comprising fibers (when various different binding agents are used)). According to an exemplary embodiment, material properties with two/varying process temperatures improved may be obtained and/or various more complex forms may be able to be produced in components. (According to an exemplary embodiment, bringing the mold into its closed position and applying the pressing force for forming the molded body at the second process temperature may be performed at the same time as or prior other sequence.)

According to an exemplary embodiment, sections of the mold (i.e., the top and bottom part) may be brought to or held at the first process temperature in the first method step; when provision is made for a second process temperature the mold sections may be brought to or held at the second process temperature. (According to an exemplary embodiment, a homogenous molding and a shortening of the molding time is achievable.)

According to an exemplary embodiment, the part or sections of the mold may be brought to or respectively held at the first and/or second process temperature by flowing a heat-transmitting liquid through the section; use of heat-transmitting liquid/fluid such as a thermal oil may serve as a heat-transfer medium transported through the mold part/section or sections. The liquid/fluid or thermal oil may be transported through a heat source by means of a circulation pump; the source may be a simple (and safe) non-pressurized source supplying of the mold sections with the heat required to reach the respective process temperature. According to an exemplary embodiment, other systems for warming the mold/mold sections may be used such as an electric heater able to be integrated into the tool (or heating of the sections of the tool by induction, etc.)

According to an exemplary embodiment, the bottom part of the mold comprises a surface impermeable to the material comprising fibers to be introduced; no air outlet openings are provided in the bottom part of the mold (e.g. not necessary since in contrast to conventional molding tools, no hot air needs to be introduced into the mold method to thermally activate the binding agent of material comprising fibers). According to an exemplary embodiment, the mold sections are heated to the process temperature; a discharge and/or recirculation of material comprising fibers inadvertently blown out during the blowing process is no longer necessary at the bottom part of the mold.

According to an exemplary embodiment, the top part of the mold may be designed to be air-permeable (i.e. provided with air outlet holes); the top part of the mold may only serve in equalizing pressure when the mold is brought from its open into its closed state.

According to an exemplary embodiment, the material comprising fibers may contain a percentage of synthetic fibers (e.g. polymer fibers and/or carbon fibers); polyethylene (PE), polypropylene (PP) and/or polyethersulfone (PES) may be used as polymer fibers. According to an exemplary embodiment, the material comprising fibers may contain a percentage of natural fibers (e.g. wood fibers and/or cotton fibers).

According to an exemplary embodiment, the system may comprise a mold having a bottom part/section and at least one top part/section able to move in relation for applying a pressing force on a material comprising fibers introducible into an intermediate mold space formed between the parts; the bottom part of the mold has a surface which is impermeable to the material comprising fibers to be introduced and at least one of the mold parts is designed to be brought to a selectable process temperature by means of a heat-transmitting liquid flowing through a part (e.g. a thermal oil).

According to an exemplary embodiment, the bottom part of the mold may be able to move between an introducing position and a pressing position; at least one top part of the mold is provided at the introducing position and at least one top part of the mold is provided at the pressing position.

According to an exemplary embodiment, a suitable top section (e.g. heated to the first process temperature) may be furnished to the bottom part for realizing the method steps up to and including the introduction of the material comprising fibers; according to an exemplary embodiment, the system/method may use a blow mold section supplied with material comprising fibers at a blowing station for the material comprising fibers (e.g. feed device or supply) to dispense through a nozzle arranged in the mold.

According to an exemplary embodiment in a multi-stage process in the mold/forming system, the bottom part/section is transported to a top part/section which may be a part of a pressing device and used to exert the pressing force; according to an exemplary embodiment as shown schematically, the molded body is fully formed without interrupting the curing process so as to enable the achieving of a continuous duroplastic process.

According to an exemplary embodiment, only one pressing device is used (e.g. successively fed correspondingly prepared bottom mold section/parts from one station or multiple stations (e.g. introducing the material comprising fibers takes longer than the subsequent pressing process). According to an exemplary embodiment, the method may be executed more efficiency (e.g. less costly and more economically).

FIGS. 1A and 1B show an exemplary embodiment of a vehicle V having an interior passenger compartment I configured to include one or more components (e.g., trim panels). The vehicle V may include a door assembly including one or more door trim panels 110 and an instrument panel IP assembly including one or more instrument panels IP. The vehicle V may include a seat assembly including one or more seat trim panels. The vehicle V may include a center console assembly that includes one or more trim panels 114. The vehicle V may include additional trim panels associated with other assemblies of the vehicle V. Any of the components of the vehicle V may be configured according to any of the embodiments disclosed and/or may be manufactured (e.g., made) according to any of the methods disclosed.

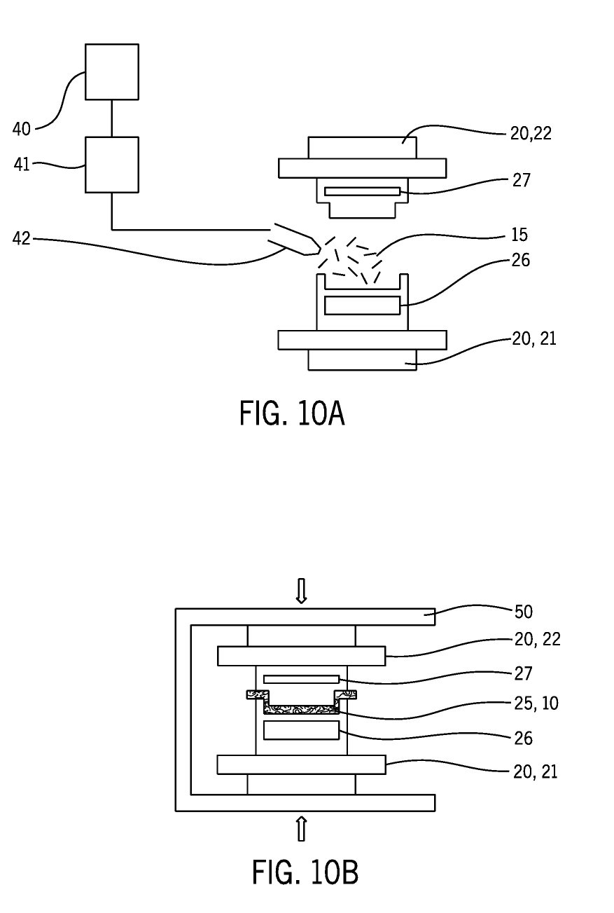

FIG. 10A shows a schematic sectional side view of a device according to an exemplary embodiment.

According to an exemplary embodiment, a blow molder 41 supplies a blow nozzle 42 with material comprising fibers which is supplied by a material comprising fibers feed device of the blow molder 41.

According to an exemplary embodiment, the blow nozzle is arranged with its outlet opening at the bottom part 21 of a mold 20 so that material comprising fibers 15 will be blown out onto bottom part 21. The material comprising fibers may comprise a percentage of natural fibers (e.g., cotton fibers) as well as a proportion of a binding agent which may be thermally activated and hardens duroplastically. See e.g. FIGS. 7A and 7B (material comprising fibers formed into panels 510x and 610x).

According to an exemplary embodiment, a top part 22 of the mold 20 is provided opposite the bottom part 21 and spaced from bottom part 21 so as not to impede the introduction of the material comprising fibers 15. The distance between bottom part 21 and top part 22 is shown schematically according to an exemplary embodiment in FIG. 10A; as the two parts may be arranged close together when the material comprising fibers 15 is being blown in (e.g. supplied from the feeder system); as indicated, the distance of separation between the sections/parts 21, 22 is such that no pressing force is applied in the stage of feeding the material comprising fibers.

According to an exemplary embodiment, both the bottom part 21 and the top part 22 of the mold 20 are each provided with a fluid channel 26, 27 through which heated thermal oil is conducted (e.g. supplied from the heating system) as shown schematically. The thermal oil serves as a heat-transfer medium and is circulated through a heating device so that the top part 22 and the bottom part 21 are heated to a temperature of approximately 220 degrees Celsius. The material comprising fibers 15 is deposited on hot mold surfaces when blown out; the binding agent component is already activated upon being blown onto the mold parts 21, 22. The bottom part 21 of the mold is of solid configuration (constitutes a heavyweight tool) and has no air openings on its surface receiving the material comprising fibers 15 so that no recirculating (discharging or the like) needs to be provided for surplus material comprising fibers 15.

As shown schematically in FIG. 10B, before the duroplastic hardening of the portion of binding agent in the material comprising fibers 15 may no longer permit any further simple forming action; the mold 20 is brought into a closed position so that an intermediate mold space 25 forms between the top part 22 and the bottom part 21. A pressing device 50 applies a pressing force on the material comprising fibers in the intermediate mold space 25 so that a molded body 10 having the corresponding material properties is produced completely by duroplastic action (which is finished following curing). According to an exemplary embodiment, applying of the pressing force is shown schematically in FIG. 10B.

FIG. 11 is a schematic diagram showing the method according to an exemplary embodiment. According to an exemplary embodiment, individual parts may be designed in conjunction with the method or process; the method according to an exemplary embodiment may only provide for one pressing device 50 for alternatingly pressing molds 20a, 20b, in each case associated with a blow molder 41a, 41b supplied by a corresponding material comprising fibers feed device 40a, 40b.

As indicated schematically, blowing material comprising fibers into the hot molds 20a, 20b may take a longer period of time than the subsequent pressing; one blow molder 41a having a cycle time of 60 seconds and a further blow molder 41b having a cycle time of 60 seconds may supply a single pressing device 50. See FIG. 11.

FIGS. 12A and 12B show schematically according to an exemplary embodiment, a component 210 (e.g., panel) for use in a vehicle. The component is made from a material comprising fibers; the component 210 may be made utilizing one of the methods disclosed; the component 210 includes a pair of ends 213 and an intermediate portion 215 extending between the ends 213; the intermediate portion 215 may be offset from the ends 213 such that the intermediate portion 215 is non-planar relative to the ends 213; the component 210 has a substantially uniform (e.g., constant) thickness throughout the component; the thickness of the intermediate portion 215 is substantially the same as the thickness of each end 213; the component 210 has a substantially uniform (e.g., constant) density throughout the component; the density of the intermediate portion 215 is substantially equal to the density of each end 213. According to an exemplary embodiment, the component 210 is configured to carry a relatively constant load throughout the component; if the component 210 is used in an assembly where a portion of the component 210 is subjected to a high load area (e.g., a load that would otherwise be higher than the load carrying ability of the component) then the component 210 may be modified to accommodate the high load. An example of modification is to increase the thickness of the entire component 210 to accommodate the high load which may increase the weight of the component and affect design of the portions of the component not subjected to the high load; another example of such a modification is to include a support (e.g., a structural support, support member, etc.) that reinforces the component 210 local to the location where the component is subjected to the high load. As shown in FIG. 12B, a support 220 is located behind the portion of the component 210 that is subjected to the high load, which is shown to be the intermediate portion 215 such that support 220 carries load transferred into the portion of the component 210. According to an exemplary embodiment, the support 220 may be coupled to a back side (e.g., a rear surface) of the intermediate portion 215 of the component 210. Other examples of such modifications are provided by the components 310, 410 shown in FIGS. 2A and 2B.

FIG. 2A shows according to an exemplary embodiment, a component 310 made using material comprising fibers (e.g., loose fibers); the component 310 may be made utilizing one of the methods disclosed in the application; the component 310 may include a pair of ends 313 and an intermediate portion 315 extending between the ends 313; the intermediate portion 315 has a thickness T1 that is larger than a thickness T2 of the ends 313 such that the intermediate portion 315 is configured to carry a relative higher load compared to the ends 313. According to an exemplary embodiment, the density of the intermediate portion 315 may be the same as the density of the ends 313 and the component 310 still provides a higher load carrying ability through the intermediate portion 315. The thicknesses T1 and T2 (and the difference between the thicknesses) may be tailored (e.g. designed or adjusted) to the specific application of the component.

FIG. 2B shows according to an exemplary embodiment, a component 410 made using material comprising fibers which may be made utilizing one of the methods disclosed in the application. The component 410 may include a pair of ends 413 and an intermediate portion 415 extending between the ends 413. As shown schematically, the intermediate portion 415 has a thickness that is substantially the same as the thickness of the ends 413. According to an exemplary embodiment, the intermediate portion 415 has a density that is higher (e.g., larger, etc.) compared to the density of the ends 413, such that the intermediate portion 415 is configured to carry a relative higher load compared to the ends 413. The densities of the intermediate portion 415 and the ends 413 (and the difference between the densities) may be tailored (e.g. designed or adjusted) according to an exemplary embodiment to the specific application of the component.

According to an exemplary embodiment as shown schematically in FIGS. 2A and 2B, the intermediate portions 315, 415 of the components 310, 410 may be subjected to a higher load relative to the ends 313, 413 of the components 310, 410 by increasing the thickness and/or the density of the intermediate portions 315, 415 compared to the thickness/density of the ends 313, 413. According to an exemplary embodiment, the sections having increased thickness and/or density are configured to increase (e.g., improve) the integrity (e.g., strength, durability, etc.) of the component. According to an exemplary embodiment, one and/or both ends of the components 310, 410 may be configured having a larger thickness and/or density relative to intermediate portion to allow for carrying the relative higher load in other portions of the components; each component may have a greater thickness and/or density at a location other (or in addition to) than the intermediate portions shown. According to an exemplary embodiment, the components may be configured having more than one location having a greater thickness and/or density to provide a component that may carry a relative high load in one or more locations and carry a relative low load in one or more locations. According to an exemplary embodiment, the components may include a plurality of sections configured with more than two different thicknesses and/or densities, such as to carry more than two different loads in three or more different sections.

As shown schematically in FIGS. 3 and 12C according to an exemplary embodiment, methods (e.g., processes) may be provided for making (e.g., manufacturing) components (e.g., panels) for use with a vehicle such as door panels 510, 610 that are configured to be subjected to more than one load. As shown schematically in FIG. 12C, a fiber mat 515 is utilized to produce the door panel 510. The first step is producing the fiber mat 515 in accordance with conventional techniques; in the second step the fiber mat 515 is formed into the door panel 510 having a substantially uniform thickness and density throughout the panel. To allow the door panel 510 to withstand more than one load condition at different locations of the panel, a support (e.g., the support 220) is injection molded to a backside of the door panel 510 at each location of relative high loading in a third step.

According to an exemplary embodiment as shown schematically in FIG. 3, loose fibers 615 are utilized to produce the door panel 610. The first step is blowing the loose fibers 615 into a tool (e.g., molding equipment) that produces a door panel 610 having an increased thickness and/or an increased density at each location of relative high loading of the panel; in the second step, the door panel 610 is produced by the tool. Since the door panel 610 may withstand a similar load condition as the door panel 510 without having the support, the cost and timing (e.g., to manufacture) associated with adding the support may be eliminated.

FIGS. 4A to 4F show an exemplary method for producing a component 710 (e.g., a panel) for a vehicle in five steps (e.g., process implementation steps). In the first step (see FIG. 4A), loose fibers 715 (e.g., separate fibers) are blown (e.g., injected, introduced, disposed such as by a fluid medium, etc.) into a cavity C of a tool/apparatus M (e.g., mold) such as by a feeder apparatus or system F (shown schematically). The fibers 715 may be blown into the cavity C with other elements. The separate fibers may be blown into the cavity along with a binder, a reinforcing material (e.g., carbon fibers, glass fibers, etc.), and/or a filler. A nozzle N may be fluidly connected to a compartment of the feeder/system F that holds the loose fibers 715 by a fluid conduit FC (e.g., hose, tube, pipe, etc.). The separate fibers 715 are blown into the cavity C via the nozzle N, which may be coupled to a part of the tool/apparatus M.

According to an exemplary embodiment, the tool/apparatus M includes a first (e.g., upper, top) part/section MT and a second (e.g., bottom, lower) part/section HMT, where at least one of the first and second parts is movable relative to the other part between an open position and a closed position. See e.g. FIGS. 4A, 5A and 6A. In the first step, loose fibers 715 are blown into the cavity C formed between the first part/section MT and second part/section HMT in the closed position. As shown schematically, the fibers 715 are deposited on a mold surface of the second part/section HMT between the mold surface of the second part/section HMT and a mold surface of the first part/section MT. According to an exemplary embodiment, at least one mold surface is permeable to air but impermeable to the separate fibers of the material comprising fibers being blown into the mold; the arrangement allows the air medium that is blown in with the separate fibers to escape without the cavity without the fibers escaping the cavity. As shown schematically in FIGS. 4A to 4F, the first part/section MT includes a mold surface 724 that is configured to be permeable to air but impermeable to the separate fibers 715. According to an exemplary embodiment, the mold surface 724 of the first part/section MT may include a screen that has a shape that conforms the fibers to a specific geometry without allow the fibers to pass through apertures in the screen. According to an exemplary embodiment, air is permitted to pass through the apertures of the screen in the mold surface 724. According to an exemplary embodiment, at least one mold surface is impermeable to both air and to the fibers. As shown in FIG. 4A to 4F, the second part/section HMT includes a mold surface 727 that is impermeable to both air and to the fibers 715 blown into the cavity C; the mold surface 727 may be solid (e.g., continuous).

According to an exemplary embodiment, one or both of the first part/section MT and second part/section HMT may be heated to a first temperature prior to introducing the fibers 715 into the cavity. The first temperature may be configured to activate at least some of the fibers 715 such as where polymerization and/or cross-linking of fibers 715 occurs; the first temperature is above a threshold temperature of the material comprising fibers to begin activating the material comprising fibers; activating at least some of the fibers may advantageously help retain all of the fibers 715 in place until all of the fibers are activated.

As shown schematically in FIGS. 4A to 4F, the second part/section HMT and third part/section HMB of the tool/apparatus M are heated, while the first part/section MT remains unheated. The second part/section HMT may be preheated to a first temperature (which is above the threshold temperature of the material comprising fibers) prior to blowing in the fibers 715 then may be heated to a second temperature that is greater than the first temperature between blowing in the fibers 715 and compressing the fibers 715 into the component 710. The third part/section HMB of the tool/apparatus M may be similarly preheated then heated to the second temperature while compressing the fibers 715 between the second part/section HMT.

As shown schematically in FIG. 4A to 4F, the system includes a heater shown schematically as a heating system H (e.g., heat exchanger/system, heating elements, heating mechanism, etc. with control system) that is configured to heat the tool/apparatus M such as one or more parts. As shown, the heating system/mechanism is configured to heat the second part/section HMT and the third part/section HMB of the tool/apparatus M; the heater/system H may be configured to heat any one part or any combination of parts of the tool. According to an exemplary embodiment, the heater/system H utilizes a heated fluid to heat the tool. The heater/system H may include a heater and a pump where the heater heats the fluid and the pump supplies/pumps it through the system; the heater/system H may utilize electric heat or any suitable conventional heating technique according to an exemplary embodiment (e.g. including heating elements in or with the sections/parts of the apparatus/tool such as heated mold bottom section HMB and heated mold top section HMT as shown in the FIGURES).

According to an exemplary embodiment, one or both of the first part/section MT and second part/section HMT may be configured as heavyweight tool parts. A heavyweight tool part is configured having a mold surface 724 and 727 for forming the part (e.g., the component 710) that is continuous or unbroken by openings (e.g., holes, apertures, etc.) such as to allow air flow into/out of the cavity C. The arrangement prevents the fibers 715 from flowing through any openings which could otherwise lead to voids in the parts being formed and/or damage to the tool/apparatus M. The mold surface of a heavyweight tool is devoid of any openings (other than an opening that forms a feature on the component such as a protrusion, tab, or similar element).

In the second step (see FIG. 4B), one of the first part/section MT and second part/section HMT of the tool/apparatus M moves to the open position. As shown, the first part/section MT moves in an upward (e.g., vertical) direction away from the second part/section HMT until the first part/section MT clears the fibers 715 to allow the second part/section HMT (and the fibers 715 on top of the second part/section HMT) to move relative to the first part/section MT in a direction transverse to the direction that the first part/section MT moves in.

In the third step (see FIG. 4C), the part of the tool/apparatus M having the fibers 715 is moved. As shown schematically, the second part/section HMT moves in a transverse direction (e.g., horizontal) relative to the direction that the first part/section MT moves in the second step to position the second part/section HMT and the fibers 715 disposed under a third part/section HMB of the tool/apparatus M.

In the fourth step (see FIG. 4D), the third part/section HMB of the tool/apparatus M is moved downward relative to the second part/section HMT to bring the third part and second part into a closed position in which mating mold surfaces of the second part/section HMT and third part/section HMB compress the fibers 715 with a pressure from force F to form a component 710. The length of time that the second part/section HMT and third part/section HMB are in the closed position may depend on the temperature of the tool (e.g., each part) and the pressure used to compress the fibers 715.

The third part/section HMB may be heated to a temperature (e.g., the first temperature) prior to moving to the closed position with the second part/section HMT. During the fourth step, one or both of the second part and third part/section HMB may be heated to a temperature (such as a second temperature that is higher than the first temperature) to facilitate activating all of the fibers 715. The third part/section HMB of the tool/apparatus M may be configured as a heavyweight tool part.

In the fifth step (see FIG. 4E), the third part/section HMB of the tool/apparatus M is moved from the closed position to the open position to allow the component 710 to be removed from the second part/section HMT of the tool/apparatus M. The component 710 may be removed manually (e.g., by an operator) or automatically (e.g., by the tool/apparatus M). As shown, the shapes of the mating mold surfaces of the second part/section HMT and third part/section HMB define the geometry (e.g., shape) of the component 710. The mating mold surfaces may form a component 710 having a uniform thickness.

FIGS. 5A to 5F show producing a component 810 (e.g., a panel) for a vehicle having different sized (e.g., thickness) portions using the steps (e.g., processes) shown in the process in FIGS. 4A to 4F.

As shown schematically in FIG. 5A to 5F, the fibers 815 form a shape that is generally similar to the shape of the finished component 810 in the first two steps (see FIGS. 5A and 5B) via the first part MT and second part HMT of the tool M; the partially activated fibers 815 forming the general shape is moved with the second part HMT (see FIG. 5C). The component 810 is formed between the second part HMT and third part HMB of the tool M (see FIGS. 5D and 5E). The relative spacing between the mold surface 827 of the second part HMT and the mold surface 826 of the third part HMB defines the thickness of the component 810 in that specific location (e.g., section, region, area, etc.). The component 810 may be formed having different thicknesses in different sections of the component. According to the example shown in FIGS. 5A to 5F, the component 810 includes a first end 811 having a thickness of T1, a second end 812 (opposite to the first end 811) having a thickness of T2, and an intermediate section 813 located between the first and second ends that has a thickness of T3. The thicknesses T1, T2, and T3 are different from one another (e.g. as indicated between each section/portion of the component). The thickness T1 may be less than the thickness T2; thickness T2 may be less than the thickness T3. As shown schematically in FIG. 5A to 5F, a first transition section 818 extends between the first end 811 and the intermediate section 813, and a second transition section 819 extends between the second end 812 and the intermediate section 813. Each transition section 818, 819 may have a thickness that varies along the section, such as transitioning from the thicknesses of the respective connected sections (e.g., end, intermediate section, etc.). According to an exemplary embodiment, the thicknesses of the sections of other components may be different than what is shown in the component 810 (which is intended to be illustrative and not limiting in nature).

According to an exemplary embodiment, the component 810 is configured having different thicknesses in different sections of the component (e.g. designed to the load conditions that each section is subject to in vehicle); the component 810 may carry different levels of loading in the different sections of the component without having to vary the density of the component from section to section. The third part HMB may be configured to compress the fibers 815 in the different sections consistently (e.g. by approximately the same amount) to maintain a relatively constant density throughout the component 810.

FIGS. 6A to 6F show schematically according to an exemplary embodiment, a method for producing a component 910 (e.g., a panel) for a vehicle having different densities in different sections (e.g., portions) using the five steps (e.g., processes) described in the process shown in FIGS. 4A to 4F.

As shown schematically in FIG. 6A to 6F, the component 910 produced has a relatively constant thickness, but is configured having different densities in different sections or portions. First section/portion 911 and second section/portion 912 of the component 910 may be configured having a first density, and a third section 913 of the component 910 may be configured having a second density that is different (e.g., greater, lower) than the first density. According to an exemplary embodiment, the process shown provides a second density that is greater than the first density but other components may be configured differently. According to an exemplary embodiment, the component 910 may be formed having different densities by compressing more fibers into a similar cross-sectional size (e.g., thickness) in sections having relatively greater densities (e.g. by adjusting the form of the forming tool).

As shown schematically in FIGS. 6A to 6F, the mold surface of the first part MT is configured having a greater offset distance (e.g., recessed) relative to the mold surface of the second part 922 through the region corresponding to the third section 913 of the component 910 relative to the regions corresponding to the first section 911 and second section 912 of the component. The surface may have a recess in the region of the third section 913 relative to the regions of the first section 911 and second section 912; during the first and second steps (see FIGS. 6A and 6B) a greater number of fibers 915 are blown into the portion of the cavity C that forms the third section 913 of the component 910 compared to the first section 911 and second section 912. The mold surface of the third part 923 of the tool is configured having a substantially similar offset distance to the mold surface 927 of the second part 922 through the first, second, and third regions corresponding to the first section 911, second section 912, and third section 913. As shown schematically in FIG. 6D, the fibers 915 are compressed between the second part 922 and third part 923. Since more fibers are being compressed into a similar cross-sectional size in the third section 913 (compared to the first section/portion 911 and second portion 912) the density of the third section 913 is greater than the densities of the first and second sections 911, 912. The component 910 is produced having a substantially uniform (e.g., constant) size (e.g., thickness) between the three sections, with the third section 913 having a greater density. The component 910 is configured for use in a vehicle application where the third section 913 is subjected to a relatively higher load condition then the load conditions of the first section 911 and second section 912. According to an exemplary embodiment, the component 910 could be made to include more than two (or more) different densities in any number of locations/portions or sections (e.g. as designed/intended for the use of the component).

FIGS. 7A and 7B show portions of exemplary embodiments of components made using the methods shown in FIGS. 3 and 12C. As shown in FIG. 7A, the orientation of the fibers 515 of the component 510x formed from a mat are randomly orientated (e.g., arranged, aligned, etc.); the fibers 615 of the component 610x formed by blowing loose fibers into the mold (e.g., via the methods shown in FIGS. 7B and 8) may have a longitudinal orientation and/or a stacked orientation throughout the component. According to an exemplary embodiment, the fibers 615 may form layers that are stacked (e.g. oriented/layers on top of one another); the arrangement may provide a more homogenous substrate or matrix of the material of the component 610x which may advantageously increase the integrity such as the strength of the component or a section of the component.

FIGS. 8A and 9A show schematically a graph showing variation or change in density (D) along length/dimension (L) of a component produced from a material comprising fibers according to an exemplary embodiment of the system/method. As indicated schematically in FIGS. 8A-8D the component is made using two mats of fibers (the first mat and the second mat shown on top of the first mat in FIG. 8B) to provide a multi-density component 510 (FIG. 8C). As shown in FIG. 8B, the second mat is placed on top of the first mat prior to compression. After compressing the two mats together, the section 511 (which include both mats) has a higher density D2 than the sections 511 (e.g. which included only the first mat having the density D1. According to an exemplary embodiment as shown schematically, the section 512 will be thicker than each section 511; the method may result in a sharp transition in density (depicted as 513 in FIG. 8A) between the lower density D1 of section 511 and the higher density D2 of section 512 which may induce a weak spot (e.g., via a stress concentration or riser due to the form/geometry of the part/design). FIG. 8D shows a component 510 according to an exemplary embodiment indicating partial integration of the two mats 511, 512 where the density is greater in the integrated portion compared to the density in the non-integrated portion.

Referring to FIGS. 9A and 9C, a component with properties is shown schematically; the component comprises a multi-density component made using blown fibers of material indicated schematically according to an exemplary embodiment. As shown in FIGS. 9B and 9C, the density of the transition 613 (located between the thinner section 611 and the thicker section 612) gradually (e.g., progressively) transitions between a relatively higher density in the section 612 to the relatively lower density in the section 611 to eliminate the potential weak spot. As shown in FIG. 9A, the thickness of the transition 613 (located between the thinner section 611 and the thicker section 612) gradually (e.g., progressively) transitions to eliminate the potential weak spot; the density of the transition section 613 (located between the low/reduced density section 611 and the high/increased density section 612 shown in FIG. 9A) may gradually transition to eliminate the potential weak spot. As indicated schematically and representationally in FIGS. 9B and 9C, the thicker section 612 of the component may be compressed in the forming step to an extent intended to produce desired properties (e.g. shape/form, thickness/density, etc.).

According to an exemplary embodiment, a three step method for producing a molded body from a material comprising fibers is provided. The method utilizes a mold that includes at least one bottom part and at least one top part able to be moved toward one another to exert a pressing force on the material comprising fibers. The top part and bottom part define an intermediate mold space for the molded body to be produced in (e.g. space or cavity for supply/formation). The first step of the method involves bringing or holding at least one of the parts of the mold to/at a first and/or the first process temperature able to at least partly activate the respective material comprising fibers. The second step of the method involves introducing the material comprising fibers into the at least partly open mold; the third step of the method involves bringing the mold into its closed position and applying the pressing force to form the molded body. See e.g. FIGS. 4A to 4E.

According to an exemplary embodiment, at least one of the parts of the mold may be brought to or held at a second and/or the second process temperature, which is higher than the first process temperature, such as during the method step of bringing the mold into its closed position and applying the pressing force for forming the molded body. All the parts of the mold may be brought to or held at the first process temperature and/or the second process temperature, according to other examples. The parts/sections of the mold may be brought to or held at the first process temperature and/or the second process temperature by a heat-transmitting liquid (e.g. thermal oil) at the respective temperature flowing through the mold section. According to an exemplary embodiment, the first process temperature may be in a range of between 150 degree Celsius and 300 degree Celsius (approximately 220 degree Celsius). See e.g. FIGS. 4A-4F.

According to an exemplary embodiment, the bottom part of the mold may include a surface that is impermeable to the material comprising fibers introduced into the mold. See e.g. FIGS. 5A-5D and 6A-6F.

According to an exemplary embodiment, the material comprising fibers may contain a percentage of synthetic fibers such as polymer fibers and/or carbon fibers; the material comprising fibers may contain a percentage of natural fibers such as wood fibers and/or cotton fibers. See e.g. FIGS. 7A and 7B.

According to an exemplary embodiment, the method/system may comprise a mold having a bottom part/section and at least one top part/section (e.g. able to move in relation for applying a pressing force on a material) comprising fibers introduced into an intermediate mold space formed between the parts. The bottom part of the mold may have a surface that is impermeable to the material comprising fibers introduced. At least one of the parts of the mold may be configured to be brought to a selectable process temperature by means of a heat-transmitting liquid (e.g. thermal oil) flowing through the part (e.g. apparatus/tool sections HMT and HMB provided heat from a heat exchanger system H as indicated in FIG. 4A operating under process control for implementation of the method).

According to an exemplary embodiment, the bottom part of the mold may be movable between an introducing position and a pressing position; at least one top part of the mold is provided at the introducing position and at least one different top part of the mold is provided at the pressing position. See e.g. FIGS. 5A-5D and 6A-6F.

It is noted at this point that the invention is not limited to the embodiments as described, embodiments are rather to be understood as being examples. Modifications and amendments of individual features will be familiar to the person skilled in the art.

The terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. These terms should be interpreted as indicating that insubstantial or inconsequential modifications or alterations of the subject matter described and claimed are considered to be within the scope of the invention as recited in the appended claims.

The terms “coupled,” “connected,” and the like, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the panels, molded bodies, tooling, etc. as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. Elements shown as integrally formed may be constructed of multiple parts or elements, the position of elements may be reversed or otherwise varied, and the nature or number of discrete elements or positions may be altered or varied.

The word “exemplary” is used to mean serving as an example, instance, or illustration. Any embodiment or design described as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. All such modifications are intended to be included within the scope of the present disclosure. Other substitutions, modifications, changes, and omissions may be made in the design, operating conditions, and arrangement of the preferred and other exemplary embodiments without departing from the scope of the appended claims.

Other substitutions, modifications, changes and omissions may also be made in the design, operating conditions and arrangement of the various exemplary embodiments without departing from the scope of the present invention. Any element (e.g., panel, molded body, tooling part, etc.) disclosed in one embodiment may be incorporated or utilized with any other embodiment disclosed. The order or sequence of any process or method steps may be varied or re-sequenced according to alternative embodiments. Any means-plus-function clause is intended to cover the structures described as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

According to exemplary and alternative embodiments, the methods and systems may be used to produce a wide variety of component forms and provide a wide variety of effects such as enhanced strength/material properties (e.g. by material selection, fiber selection/orientation, etc.), reduced weight/mass properties (e.g. by forming with composite or layered material, with voids, etc.), visual decorative effects (e.g. color, color gradations, differing or multi-color fibers/additives, variations in surface effect, translucence, simulated stitching, simulated effects, etc.), environmental-friendly composition (e.g. use of scrap and/or recycled materials/fibers), alternative geometries/shapes (e.g. with strengthening/reinforcement such as with fiber), cost (e.g. using combinations of bulk and/or high performance materials selectively), function/performance (e.g. using materials/fibers and fiber orientation to enhance functionality such as strength, cycle life, resilience, stain/wear resistance, etc.), etc. by variations of the constituents of the component formed by the system and method. According to any of the embodiments, layers or materials may be formed as or on a substrate or base. As indicated in the FIGURES, any of a wide variety of components may be formed, including but not limited to a wide variety of automotive interior components and assemblies, such as instrument panels, consoles, door panels, trim, inserts, decorative elements, lighting, functional modules, containers, and covers, and various other modules/components of such components and assemblies.

It is noted at this point that the invention is not to be limited to the exemplary embodiments depicted in the flow charts and figures but rather yields from a synopsis of all the features disclosed together. Modifications and amendments will be familiar to the person skilled in the art.

The embodiments disclosed provide components for vehicles and methods of forming the components. Besides those embodiments depicted in the figures and described in the above description, other embodiments of the present invention are also contemplated. Any single feature of one embodiment of the present invention may be used in any other embodiment of the present invention. Given the disclosure of the present invention, one versed in the art would appreciate that there may be other embodiments and modifications within the scope and spirit of the invention. All modifications attainable by one versed in the art from the present invention within the scope and spirit of the present invention are to be included as further embodiments of the present invention.

It is important to note that the construction and arrangement of the elements of the inventive concepts and inventions as described in this application and as shown in the figures above is illustrative only. Although some embodiments of the present inventions have been described in detail in this disclosure, those skilled in the art who review this disclosure will readily appreciate that many modifications are possible without materially departing from the novel teachings and advantages of the subject matter recited. All such modifications are intended to be included within the scope of the present inventions. Other substitutions, modifications, changes and omissions may be made in the design, operating conditions and arrangement of the preferred and other exemplary embodiments without departing from the spirit of the present inventions.

It is important to note that the apparatus of the present inventions may comprise conventional technology (e.g. as implemented in present configuration) or any other applicable technology (present or future) that has the capability to perform the functions and processes/operations indicated in the FIGURES. All such technology is considered to be within the scope of the present inventions and application.

1. A method of making a component for use in a vehicle from a material comprising fibers using an apparatus comprising a base section and a section creating a cavity for supply of fibers and a section for compression forming of a shape for the component comprising the steps of:
(a) heating the base section to a first temperature;
(b) supplying a material comprising fibers between the base section and the section creating the cavity for fibers;
(c) activating at least some of the fibers of the material; and
(d) forming the material comprising fibers into the shape between the base section and the section for compression forming;
wherein activating at least some of the fibers of the material comprises at least one of (a) polymerization of at least some of the fibers or (b) cross-linking of at least some of the fibers.

2. The method of claim 1 wherein the step of supplying the material comprising fibers comprises blowing fibers into the cavity; wherein the cavity is vented.

3. The method of claim 1 wherein the section for compression forming is heated.

4. The method of claim 1 wherein the base section is heated during supplying the material into the cavity and during forming of the shape.

5. The method of claim 4 further comprising activating at least some of the fibers by heating the section for compression forming.

6. The method of claim 2 wherein the section for compression forming is heated to form and activate the fibers.

7. The method of claim 1 wherein the apparatus comprises a mold.

8. The method of claim 1 further comprising heating the section for compression forming to a second temperature for compressing the material between the base section to form the shape; wherein the second temperature is higher than the first temperature.

9. The method of claim 8 wherein the first temperature is in a range from 150 degrees Celsius to 300 degrees Celsius.

10. The method of claim 1 wherein the step of supplying the material comprising fibers comprises blowing the material comprising fibers into the cavity; wherein the material comprising fibers blown into the cavity is compressed into the shape by the section for compression forming.

11. The method of claim 10 wherein the fibers of the material comprising fibers comprises at least one of a binder, a reinforcing material and a filler.

12. The method of claim 11 wherein the section creating the cavity is permeable to air and impermeable to the fibers and impermeable to the at least one of the binder, the reinforcing material and the filler.

13. The method of claim 1 wherein the component with the shape comprises one of a door panel, an instrument panel and a center console of the vehicle.

14. A system for producing a component in a shape for use in a vehicle from a material comprising fibers comprising:
(a) a first mold stage providing a cavity for fibers to be supplied comprising a base section and a section to define the cavity;
(b) a supply of the material comprising fibers into the cavity;
(c) a second mold stage for forming the shape comprising the base section and a section to form the shape by compression forming;
wherein the base section is configured to be heated to a first temperature;
wherein the section defining the cavity is vented;
wherein the section to form the shape is configured to be heated to a second temperature.

15. The system of claim 14 wherein the first temperature is in a range from 150 degrees Celsius to 300 degrees Celsius; and wherein the second temperature is higher than the first temperature.

16. The system of claim 14 wherein the first temperature is at least equal to an activation temperature of a fiber of the material comprising fibers.

17. The system of claim 14 wherein the base section and the section to form the shape comprise a compression mold; wherein the shape comprises a compression formed shape.

18. The system of claim 17 wherein the material comprising fibers remains uncompressed until the compression mold is closed to compression form the shape from the material comprising fibers.

19. A method of making a component for use in a vehicle from a material comprising fibers using an apparatus comprising a base section and a section creating a cavity for supply of fibers and a section for compression forming of a shape for the component comprising the steps of:
(a) heating the base section to a first temperature;
(b) supplying a material comprising fibers between the base section and the section creating the cavity for fibers;
(c) activating at least some of the fibers of the material; and
(d) forming the material comprising fibers into the shape between the base section and the section for compression forming;
wherein the material comprising fibers is supplied on the base section and compressed into the shape on the base section.

20. The method of claim 19 wherein the section creating a cavity is vented for blowing in fibers; and wherein the section for compression forming is heated to form the shape and activate fibers of the material comprising fibers.
